(19) United States
(12) Patent Application Publication
(10) Pub. No.: US 2016/0110795 A1
(43) Pub. Date: Apr. 21, 2016

(54) IN-STORE SOCIAL POLLING

(71) Applicant: TLM Holdings, LLC, Northfield, IL (US)

(72) Inventors: JOHN FARRAR, Chicago, IL (US); Thomas Bolling, Highland Park, IL (US)

(21) Appl. No.: 14/918,019

(22) Filed: Oct. 20, 2015

Related U.S. Application Data
(60) Provisional application No. 62/066,222, filed on Oct. 20, 2014.

(51) Int. Cl. G06Q 30/06; G06Q 50/00

(52) U.S. Cl. CPC G06Q 30/0631; G06Q 50/01

(57) ABSTRACT

A system and method for providing in-store social polling may receive request data and polling audience selection data from a consumer. The request data may be sent to multiple polling audience users associated with the selection data from the consumer. Response data associated with the request data is received from the polling audience users and the received response data is aggregated. The aggregated received response data is presented to the consumer.

### CROSS REFERENCE TO RELATED APPLICATION

This application claims the benefit of, and priority to, U.S. Prov. Appl. No. 62/066,222 filed Oct. 20, 2014, entitled “In-Store Social Polling,” the entire content of which is incorporated herein by reference.

### BACKGROUND

Stores are filled with many products. Many of the products appear similar. Determining which products are desirable and which products are not desirable to a particular user is difficult to do in the confines of a retail store. Mobile phones may be able to obtain consumer review information from a remote web site but the data is often buried inside other unwanted information. In addition, using a mobile phone inside a store is a challenge as signal strength is often weak and the time required to obtain useful information can be excessive.

New products, product enhancement, and packaging enhancements are continuously being made. The success of these products and enhancements are gauged through known marketing means such as consumer surveys that are conducted through mail, internet, and other marketing efforts that are taken after the consumer completes his shopping experience.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

A system for providing in-store social polling is disclosed. The system may include one or more processors and a memory containing processor-executable instructions that, when executed by the one or more processors, cause the system to receive request data from a requestor via a client device. The system may also receive polling audience selection data, may send request data to a plurality of polling audience users associated with polling audience selection data, and may receive response data associated with the request data from polling audience users. The system may further aggregate received response data and may present the aggregated received response data to the requestor.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 is a flow diagram of a method of in-store social polling;

FIG. 2a is an exemplary portion of a graphical user interface of the subject technology;

FIG. 2b is an exemplary portion of a graphical user interface of the subject technology;

FIG. 3 is an illustration of a mobile computing device, a server type computer device and a communication device;

FIG. 4 is an illustration of a portable computing device; and

FIG. 5 is an illustration of a server type computing device.

### DETAILED DESCRIPTION

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

Increasingly consumers have a desire to obtain and act on peer reviews. Aggregated peer review services provide unsolicited and unorganized reviews. However, there is a need for the consumer to generate his own surveys about a product or service at the point of decision or at the point of purchase with a results personalized demographic or geographic audience based on whose opinions that consumer values. A further need exists to create such surveys spontaneously, and still further yet, a need exists to receive results of such surveys in a timely manner.

The subject technology provides a system and method for a consumer to obtain and act on peer reviews by conducting in-store social polling. For example, a consumer may want to get a survey response while he is in a store before purchasing a good or service. The consumer may take a photo of the product or other related photo and select his desired audience. The photo is then distributed to the desired audience, who views the photo and responds with a “Like” or “Don't like”. The consumer then receives the results. The consumer may make his own decision based on the results of the immediate social poll that he has conducted while in the store. The subject technology may be implemented in systems including online websites, integrated with existing social media websites, or other social media mobile device applications, feed, blog, blogroll, or other outlets. The subject technology furthers provides social polling of consumer selected items in a store in real-time. The subject technology furthers provides consumer selected polling audience in-store in real-time.

One practical example is a 25-year-old male named Faruk that is out shopping for clothes to wear on his date that evening. He has found a shirt he likes, but wants the opinion of women on whether they like the item. With a mobile app of the subject technology, he takes a picture, and selects his polling audience as women of the ages 22-34. The picture is then sent out to a panel of women within the specified age rage. The panel then simply responds “Like” or “Don't Like” to the photo. The results then come back to the consumer and the consumer can make his decision to purchase the shirt with the added benefit of the results of his in-store social poll.

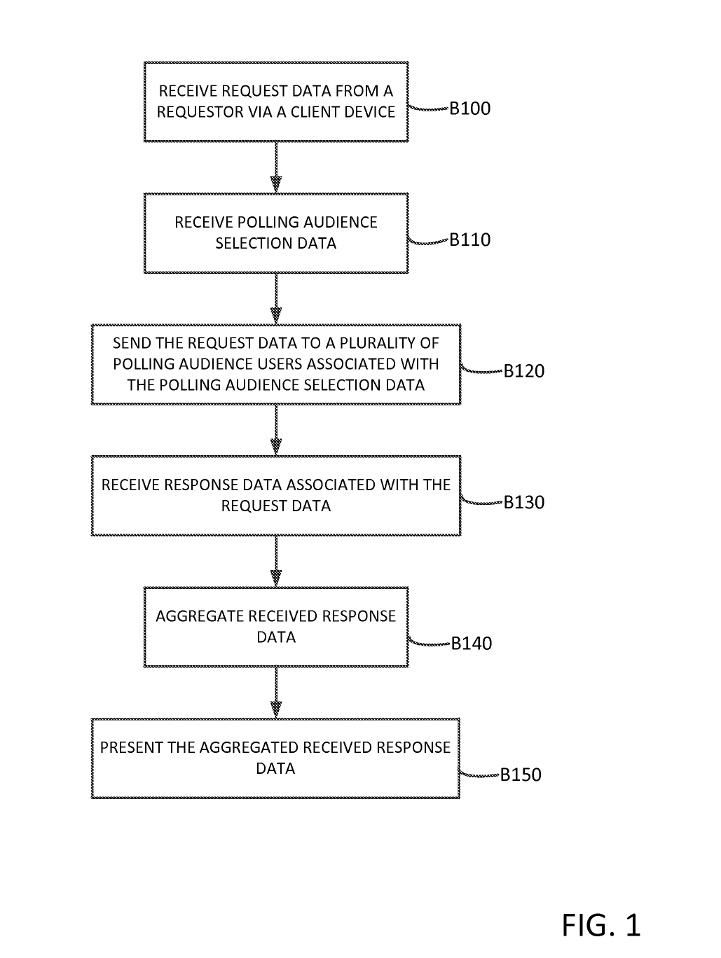

FIG. 1 is a flow diagram of a method of in-store social polling.

In block B100, request data is received from the requestor via an in-store client device 101. The in-store client device 101 may be mounted at a product display kiosk in or near a store where a consumer is shopping. The received request data may include an image, photograph, a video, a sound clip, text, or other combination of one or more types of media. For example, a beginning baking enthusiast may be grocery shopping and want some assistance selecting the right size pumpkin for a pumpkin pie. He may take a photograph of himself with a pumpkin and send a message saying “right size for pie?” The requestor (the new baking enthusiast) would then send his message via the client device to be received by server 141. Request data may be taken in-store via the client device 101. The term “in-store” as used herein encompasses its plain and ordinary meaning, including, but not limited to close to goods or services within an actual business. For example, a photograph can be taken within the store that sells the product. The meaning of close proximity is within the same physical business location sells the subject of inquiry on the device. The social polling takes place in a timely manner such that the requestor receives the results of the poll quickly enough to factor in the results of the poll in his decision making process while in the store and contemplating the purchase. In one embodiment, results may be provided in substantially real time to the requestor as the polling audience responds, with results from multiple audience users provided to the requestor in no more than approximately five minutes.

In block B110, polling audience selection data is received. The requestor may select a subset of users of the system to be the audience that is polled for a response to the request. One or more criteria may be selected by the user for each inquiry. The user may have a default polling audience that is associated with his user account if no specific polling audience is selected for a particular request. Examples of criteria include, age limitations, gender limitations, geographic limitations, education limitation data, music preference or music preference limitation data, identified interests, cuisine preference limitation data, profession, or other types of information generally available on social networks. For example, the baking enthusiast may want a polling audience of individuals employed in the pastry industry or may want a polling audience of individuals over sixteen years of age with hobbies in the culinary arts. Polling audiences may opt to limit polling audiences to users that they have a pre-existing relationship with a social network or may opt to open requests to all members of the system. To do so, the in-store client device 101 may display a graphical user interface for the consumer to select a desired audience to poll (e.g., females living in the New York City region between the ages of 22-34). In response to the user selection, the client device 101 may communicate the polling audience selection data to the server 141. The server 141 may also consider in what store a consumer is shopping, and recommend an audience to poll.

In block B120, the request data is sent to a plurality of polling audience users, wherein the polling audience users are associated with polling audience selection data. Request data is then sent to other users of the system who meet the polling audience criteria selected by the requestor. If an extremely narrow polling audience is selected (such as individuals employed in the pastry industry, limited to a rural area such as zip code 38001) only one or two users may be in the polling audience. If a larger polling audience is selected, (such as individuals over sixteen years of age with hobbies in the culinary arts—with no geographic restriction) many more users may respond, and response times may be much quicker from users, even if the system itself operates in real time. Users may be prompted to respond by selecting from response data pairs such as “like” or “don't like”; “yes” or “no”; “true” or “false”. Response data may also be of a matter of degree, such as on a scale of liking on a scale of one to ten, or awarding a number of stars from one to five. Response data may also indicate how many of the audience members did not respond. Embodiments of the subject technology are contemplated in a wide variety of different response data allowing polling audience users to respond with a single touch entry to respond. Other embodiments of the subject technology may allow users to provide a comment with the response entry. For example, the in-store client device 101 and/or the server 141 may communicate a poll message to audience client devices 101 of individuals who have signed up to be polling audience members. In response to receiving the poll message, the audience client devices 101 may display a graphical user interface and the photo on which the audience member is being asked to rate. In some instances, the poll message may be part of a loyalty program or provide other incentive to encourage audience members to participate. In an example, the incentive may decrease over time thereby incentivizing the audience member to quickly respond.

In block B130, response data is received, wherein the response data is associated with the request data communicated to the polling audience users. In an example, users of the audience client devices 101 may select that they “Like” or “Don't Like” a shirt in a photo, and the audience client devices 101 may communicate the response data including the user input to the in-store client device 101 and/or to the server 141. In the baking enthusiast example, the response data may be “yes” or “no.”

In block B 140, received response data is aggregated. In an example, the in-store client device 101 may aggregate the received response data. For example, the in-store client device 101 may determine the total number of positive responses and the total number of negative responses (e.g., 10 Likes, 5 Dislikes). In another example, the in-store client device 101 may determine an average rating given by the audience (e.g., on a scale of 1-10, with 10 being the highest rating, the average rating was 6.8). In a further example, the in-store client device 101 may determine the percentage of positive responses and the percentage of negative responses. The in-store client device 101 may perform aggregation based on one or more other statistical measures. The in-store client device 101 may also compare the aggregated response data of one product to other products. For examples, the in-store client device 101 may determine the product included in the photo, and other similar products. Similarity may be based on color, manufacturer, what other consumers purchased, and the like. The in-store client device 101 may determine aggregate response data on similar products. In another example, the server 141 may aggregate the received response data.

In block B150, aggregated received response data is presented to the requestor. In order to provide in-store social polling, speed of response is of a necessary concern. A requestor is making a decision as a consumer while simultaneously seeking the input of her social network. Accordingly, a timely response is a goal of the invention. Providing responses on a rolling basis meets this goal of the invention by providing responses as soon as they are received from the polling audience users. Responses can be aggregated and updated on the requestors display upon receipt. For example, the in-store client device 101 may aggregate the response data and present the aggregated response data to the requestor in a graphical user interface. In another example, the server 141 may communicate aggregated response data for display on the in-store client device 101. The in-store client device 101 may identify on its display the number of polling audience users that received the request, the number that have declined to respond, the number that have responded, and may additionally be provided with user identities, if the users (e.g., consumer and/or polling audience member(s)) have opted in to share such information.

In some embodiments, the user may be able to communicate the request data, response data (including comments), polling audience preferences or other information or other audio or visual inputs to other outside services such as Facebook®, Google Plus™, Twitter, blogs, emails, RSS feeds, etc. The polling audience preferences may be set up in advance. In yet another embodiment, voice recognition software may allow a user to speak the necessary information to set up the outside polling audience preferences.

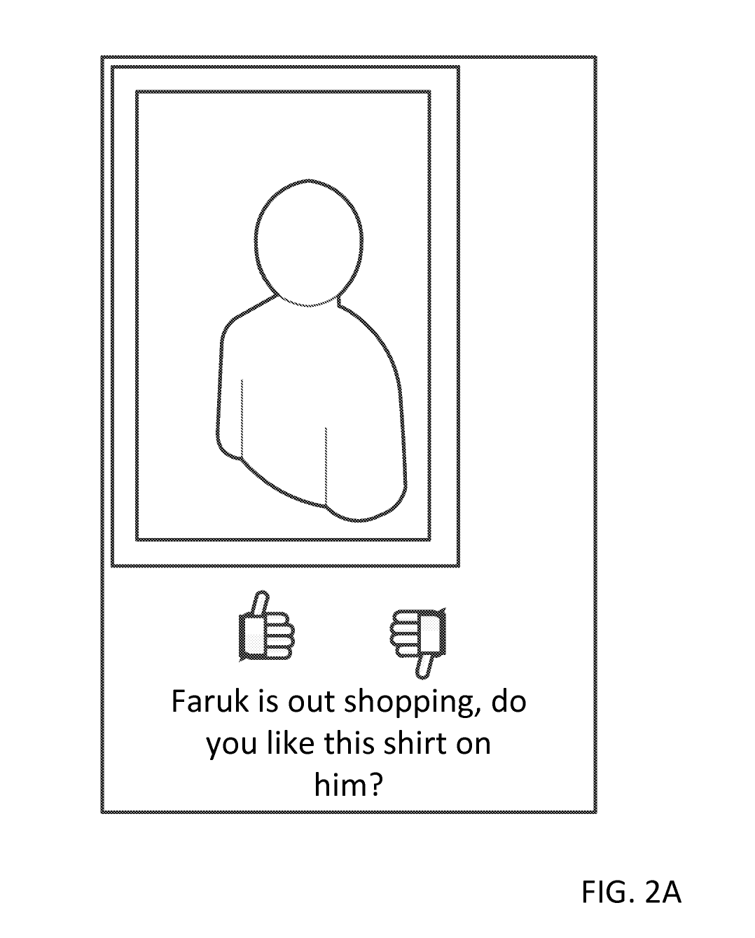

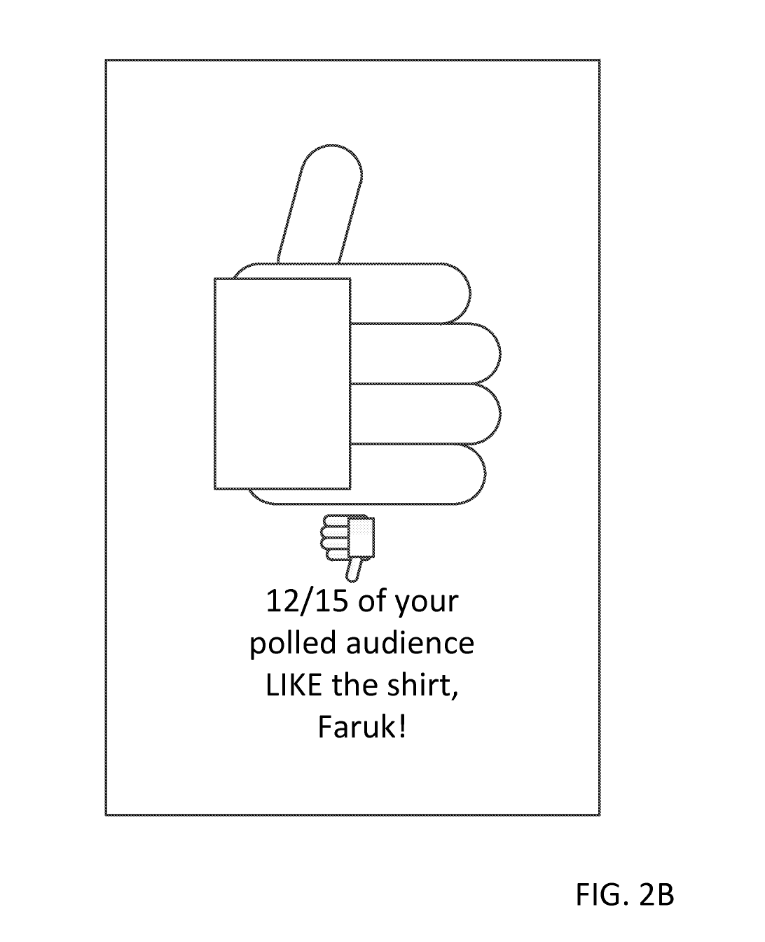

FIG. 2a is an exemplary portion of a graphical user interface of the subject technology. Once the request data is received from the requestor and the polling audience selection is received, the polling audience users meeting the polling audience selection data may receive a request that is displayed on an in-store client device 101 of the user such as the example shown in FIG. 2a. The request data may be cropped, compressed, or otherwise altered for transmission speed or design or efficiency reasons. Using the example of a gentlemen out shopping for a new shirt to wear on a date, the requestor may send a photograph of himself in a shirt he has tried on to see if the shirt is likely to be well received by his date. The request data may include the user's name and information providing some context of the user's request, or may include text inputted by the user. The polling audience users may respond to the question simply indicating approval by selecting the thumbs up or disapproval by selecting the thumbs down.

FIG. 2b is an exemplary portion of a graphical user interface of the subject technology.

Once the requestor has sent his request, the in-store client device 101 may display a graphical user interface like that of FIG. 2b, which may provide a regularly updated tally of the responses of his polling audience. The ultimate result may be visually indicated by the enlarged thumbs up, indicating that the ultimate result is positive, with the detail result being that 12 out of 15 users have responded. As more users respond, these numbers may change correspondingly to say, for example, 25 out of 29 users like the shirt.

The server 141 may also analyze the data received from in-store client devices and audience member polling devices for assisting a retailer in making marketing and inventory-management decisions. In an example, a retailer may have stores at one or more locations (e.g., nationwide) each having one or more in-store client devices 101 included therein. The client devices 101 may communicate response data to server 141 via a computer network. The response data may include one or more of product data, time and place data, polling audience data, and purchase data. For example, when a user tries on an article of clothing, a client device 101 may generate product data on the article of clothing, such as color, manufacturer, and what the article of clothing is (e.g., shirt, socks, pants, hat, etc.). The in-store client device 101 may also generate time and place data about where the user is physically located (e.g., geographic location of the store) and the time and date when the consumer tried on the product or requested the poll. The client device 101 or server 141 may generate polling audience data to indicate how online users responded to the product (e.g., 75% liked a shirt). A point of sale client device 101 may communicate with an in-store client device to determine whether the consumer proceeded to purchase the product, and the point of sale client device 101 may communicate purchase data to indicate whether or not the user bought the product after receiving the polling audience feedback (e.g., made a purchase within a predetermined amount of time after receiving the polling audience feedback).

The server 141 may aggregate the response data for use by retailers and/or manufacturers in making decisions on future product assortment, product distribution, and advertising decisions. In an example, the server 141 may assist a retailer in determining which products to showcase on its website. At some time, a user may open a software application (e.g., an app) or access a website associated with a retailer using a client device, which may be a smart phone, tablet computer, computer, and the like. The client device may communicate a request and the server 141 may select which product(s) to present via a display of the client device. The request may include, for example, geo-location data of the requesting client device.

To determine which product(s) to showcase on the website, the server 141 may access a list of available products to promote and rank the list. The ranking may be based on polling audience data history and purchase history of the products. For example, the server 141 may score the products based on a positive vote percentage indicating the percentage of positive votes each product received and a purchase percentage indicating the percentage of each product that was voted on and subsequently purchased. The server 141 may rank the products based on their score. In an example, a score may be a function of the positive vote percentage and the purchase percentage. Example functions include simple addition, weighted addition, an average, a weighted average, and the like. For instance, the function may be: score=positive vote percentage*weight1+purchase percentage*weight2.

In some examples, the polling audience data history and/or purchase history data may be associated with a particular time frame, and exclude or reduce reliance on older data. For example, the server 141 may weight the polling audience data history and/or purchase history data based on its age, giving a higher weighting to more recent data (e.g., within the past 2 weeks) and a lower weighting to older data (e.g., more than 2 weeks old). Thus, the server 141 may track trends in consumer preferences and the rankings may reflect those trends.

In some instances, the server 141 may generate the scores received from the in-store client devices 101 accounting for geo-location. In an example, the server 141 may only use polling audience data history and purchase history data that was generated by client devices 101 situated within a predetermined distance of a particular geo-location. For example, the server 141 may generate the scores based on client devices 141 within a particular city (e.g., New York) and exclude data from all other geo-locations.

In some instances, the server 141 may generate the scores received from client devices 101 accounting for changes in rankings. In an example, the server 141 may process polling audience data history and purchase history data to determine what products are increasing their scores and corresponding rankings over time, and those whose scores are decreasing. For example, the server 141 may determine that a first product has increased its ranking over a predetermined amount (e.g., moved up 50 spots in three days).

The server 141 may reply to a website request by communicating an image of a product having the highest ranking to the requesting client device. In some examples, the server 141 may communicate an image of products having the highest rankings (e.g., top 2 products, top 3, etc.). In other examples, the server 141 may consider changes in rankings and select an image of a product that has recently increased its ranking by at least a predetermined amount (e.g., moved from top 85% to top 55% in one week). Thus, the server 141 may help a retailer to advertise products that are well-liked and frequently purchased in an app, website, or other graphical user interface. Moreover, the server 141 may control what products are displayed at the in-store client device 101 when a consumer first approaches, and the server 141 may cause the in-store client device 101 to display images of highly ranked products (e.g., within top 40%). The server 141 may also determine current inventory levels of a particular store and cause the in-store client device 101 to only display highly ranked products that are currently in-stock at a particular store.

In addition to advertising, the server 141 may utilize similar concepts for assisting retailers in organizing shelf space. Using the ranking methodology described above, the server 141 may provide ranking information on a number of products currently in a store's inventory to recommend placing products that are well-liked and frequently purchased in high traffic areas of a store or other retail environment.

The server 141 may also utilize the ranking methodology for inventory management and control. In an example, the server 141 may use the product rankings and trends for automatically ordering products for delivery to certain geo-locations. For example, the server 141 may track rankings of products to control what products are kept in inventory by a store in the Kansas City area. For example, the server 141 may generate product rankings based on polling audience data history and purchase history data received from client devices 101 located in the Kansas City area. The server 141 may also expand the dataset to include similar cities. For example, the server 141 may determine what cities are considered to be similar based on comparing polling audience data history and purchase history data to determine what cities like and buy the same products in aggregate. The server 141 may maintain a listing of what products are currently in stock and quantity at a store, and/or may interface with an inventory computer system having such information.

The server 141 may determine when to reorder product based on the quantity levels, sales rate (e.g., sell three of a particular shirt per day), rankings, trends, and shipping time. For example, the server 141 may set thresholds for quantity level, sales rate, ranking, trends, and shipping time for controlling when the server 141 automatically generates an order for a product. The server 141 may automatically reorder a product when one or more of the quantity levels of the product currently in-stock falls below a predetermined number, the product has at least a certain ranking (e.g., in the top thirty-three percent), the ranking of the product is not decreasing by more than a predetermined amount, and the store is expected to sell-out of inventory in less than a predetermined amount of time based on a current sales rate. In a more detailed example, the server 141 may determine that a store has 50 units of a particular shirt in inventory, the shirt is ranked in the top twenty percent of products, sells at fifteen shirts per day, has increased its ranking from being within the top fifty percent within the past week, and ships in 2 days. Here, the server 141 automatically reorders the shirt because it meets one or more of the criteria. The server 141 may also control machinery at a manufacturing facility and may automatically submit an order that instructs the machinery to fabricate the product being reordered. In some instances, the server 141 may also control a robotic system for loading the fabricated product onto pallets for shipping the product to a desired location (e.g., a warehouse or a store of a retailer).

In additional example embodiments, a retail manager may want to be kept informed on current inventory levels at one or more stores based on the polling audience data. To do so, the retail manager may have a manager client device 101 that is configured to communicate with the server 141 via network 121. In some instances, the manager client device 101 may or may not be in an active state. For example, the manager client device 101 may be in a sleep mode to conserve battery life. Because inventory levels may be time sensitive, the server 141 may communicate an alert when an inventory level drops below a predetermined level for a product having a sufficiently high ranking (e.g., top 20%) based on the polling audience data. The alert may cause the manager client device 101 to exit the sleep mode and enter an active state. In some examples, the manager client device 101 may, in response to receiving the alert, perform one or more of the following: display the alert on a graphical user interface (GUI), display the product having low inventory and the current quantity in stock at a store and/or at one or more nearby stores, emit a sound, prompt the retail manager to reorder and/or to contact nearby stores, and/or establish a network connection for receiving additional data from the server 141 about the alert. For example, the alert may identify a nearby store having additional quantity of the product for a store experiencing a low inventory level.

The examples embodiments may thus provide a technical solution to a technical challenge. Conventional systems fail to provide a mechanism for polling audience members via a social network while a consumer is in-store and utilizing audience polling data to assist (1) consumers in making purchasing decisions, (2) retailers in organizing their websites, and (3) retailers in controlling inventory.

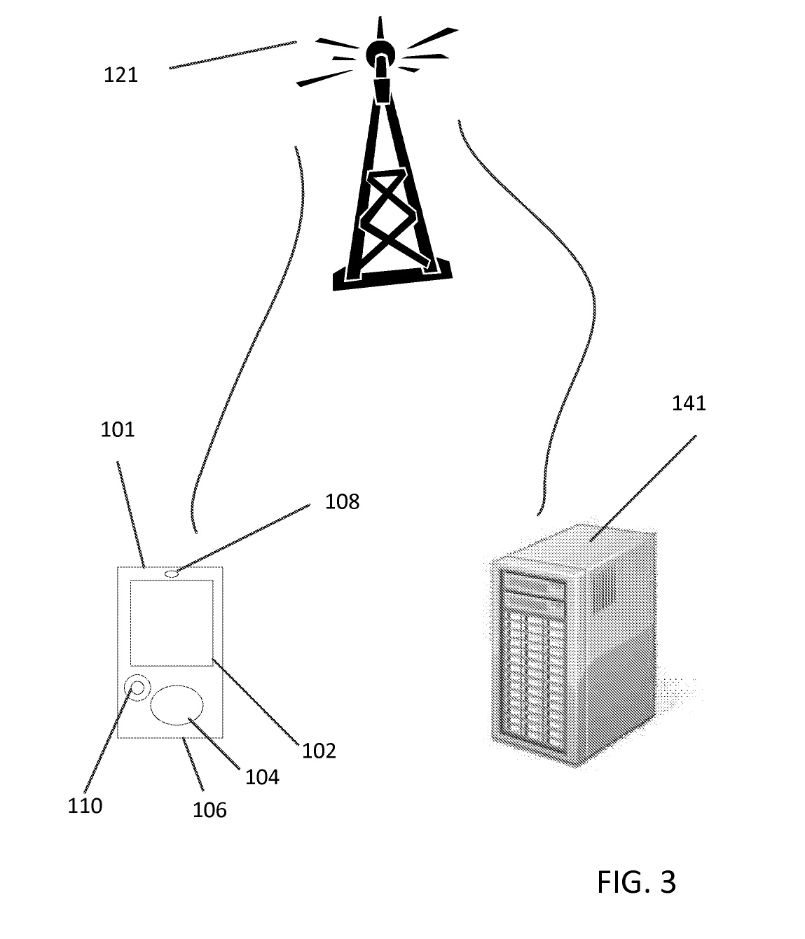

FIG. 3 may be a high level illustration of some of the elements a sample computing system. The computing system may be a dedicated computing device 141, a dedicated portable computing device 101, an application on the computing device 141, an application on the portable computing device 101 or a combination of all of these. FIG. 3 may be a high level illustration of a portable computing device 101 communicating with a remote computing device 141 but the application may be stored and accessed in a variety of ways. The server 141 may be, for example, a remote computing device. In addition, the application may be obtained in a variety of ways such as from an app store, from a web site, from a store WiFi system, etc. There may be various versions of the application to take advantage of the benefits of different computing devices, different languages and different API platforms.

In one embodiment, a client device as described herein may be a portable computing device 101 that operates using a portable power source 155 such as a battery. The portable computing device 101 may also have a display 102 which may or may not be a touch sensitive display. More specifically, the display 102 may have a capacitance sensor, for example, that may be used to provide input data to the portable computing device 101. In other embodiments, an input pad 104 such as arrows, scroll wheels, keyboards, etc., may be used to provide inputs to the portable computing device 101. In addition, the portable computing device 101 may have a microphone 106 which may accept and store verbal data, a camera 108 to accept images and a speaker 110 to communicate sounds.

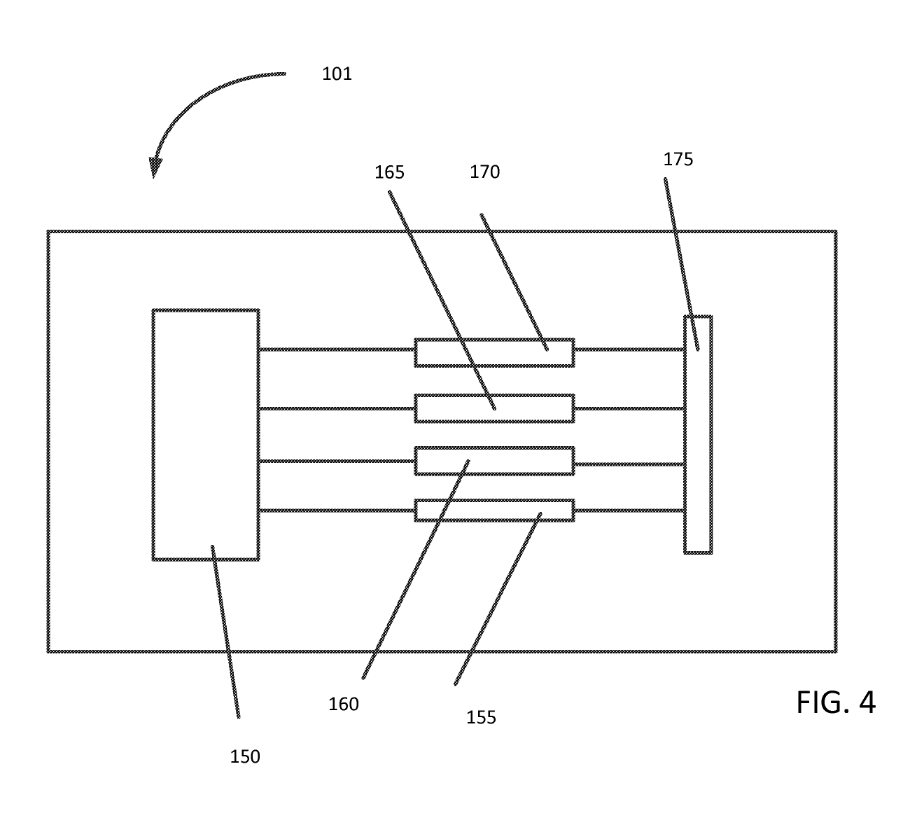

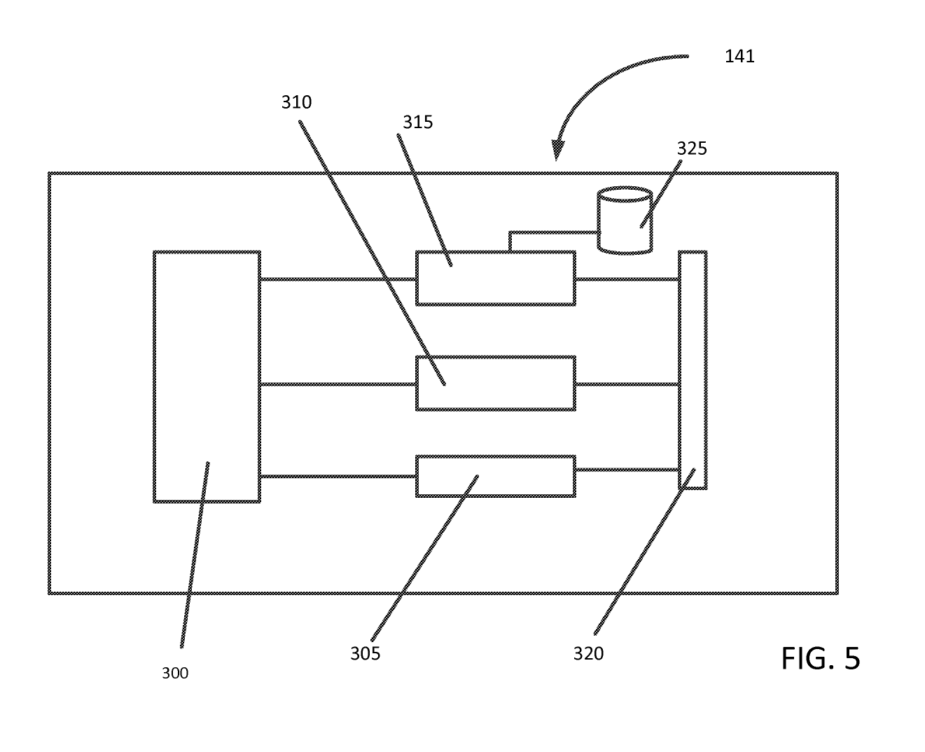

The portable computing device 101 may be able to communicate with a computing device 141 or a plurality of computing devices 141 that make up a cloud of computing devices 111. The portable computing device 101 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 141 or may be through a communication network 121 such as cellular service, through the Internet, through a private network, through Bluetooth, etc. FIG. 4 may be a simplified illustration of the physical elements that make up a portable computing device 101 and FIG. 5 may be a simplified illustration of the physical elements that make up a server type computing device 141.

FIG. 4 may be a sample portable computing device 101 that is physically configured according to be part of the system. The portable computing device 101 may have a processor 150 that is physically configured according to computer executable instructions. It may have a portable power supply 155 such as a battery which may be rechargeable. It may also have a sound and video module 160 which assists in displaying video and sound and may turn off when not in use to conserve power and battery life. The portable computing device 101 may also have volatile memory 165 and non-volatile memory 170. There also may be an input/output bus 175 that shuttles data to and from the various user input devices such as the microphone 106, the camera 108 and other inputs 102, etc. It also may control of communicating with the networks, either through wireless or wired devices. Of course, this is just one embodiment of the portable computing device 101 and the number and types of portable computing devices 101 is limited only by the imagination. The portable computing device 101 may act as the display 200 or may be a part of the display 200.

The physical elements that make up the remote computing device 141 may be further illustrated in FIG. 5. At a high level, the computing device 141 may include a digital storage such as a magnetic disk, an optical disk, flash storage, non-volatile storage, etc. Structured data may be stored in the digital storage such as in a database. The server 141 may have a processor 300 that is physically configured according to computer executable instructions. It may also have a sound and video module 305 which assists in displaying video and sound and may turn off when not in use to conserve power and battery life. The server 141 may also have volatile memory 310 and non-volatile memory 315. Memory described herein may be non-transitory and may be configured to store computer executable instructions that, when executed by at least one processor, cause at least one processor, device, computer, and the like to perform the functions described herein.

The database 325 may be stored in the memory 310 or 315 or may be separate. The database 325 may also be part of a cloud of computing device 141 and may be stored in a distributed manner across a plurality of computing devices 141. There also may be an input/output bus 320 that shuttles data to and from the various user input devices such as the microphone 106, the camera 108, the inputs 102, etc. The input/output bus 320 also may control of communicating with the networks, either through wireless or wired devices. In some embodiments, the application may be on the local computing device 101 and in other embodiments, the application may be remote 141. Of course, this is just one embodiment of the server 141 and the number and types of portable computing devices 141 is limited only by the imagination.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

1. A system for providing in-store social polling, the system comprising:
one or more processors: and
a memory containing processor-executable instructions that, when executed by the one or more processors, cause the system to:
receive request data from a requestor via a client device;
receive polling audience selection data;
send the request data to a plurality of polling audience users associated with polling audience selection data;
receive response data associated with the request data;
aggregate received response data; and
present the aggregated received response data.

2. The system of claim 1, wherein the received request data includes a photograph taken in-store via the client device.

3. The system of claim 2, wherein the aggregated received response data is presented to the requestor while the requestor is in-store.

4. The system of claim 1, wherein the polling audience selection data includes at least one of the group of: age range limitation data, gender limitation data, geographic limitation data, education limitation data, music preference limitation data, or cuisine preference limitation data.

5. The system of claim 1, wherein the received response data comprises a “like” or “don't like” response for each of the polling audience users providing a response.

6. The system of claim 1, the memory further comprising instructions to:
aggregate the number of polling audience users from which no response was received; and
present the number of non-responsive polling audience users to the requestor.

7. The system of claim 1, the memory further comprising instructions to select a product for display via a graphical user interface based on the aggregated received response data.

8. A computer-implemented method comprising:
receiving request data from a requestor via a client device;
receiving polling audience selection data via the client device;
sending request data to a plurality of polling audience users associated with the polling audience selection data;
receiving response data associated with the request data from the polling audience users;
aggregating the received response data; and
presenting the aggregated received response data.

9. The method of claim 8, wherein the received request data includes a photograph taken in-store via the client device.

10. The method of claim 9, wherein the aggregated received response data is presented to the requestor while the requestor is in-store.

11. The method of claim 8, wherein the polling audience selection data includes at least one of the group of: age range limitation data, gender limitation data, geographic limitation data, education limitation data, music preference limitation data, or cuisine preference limitation data.

12. The method of claim 8, wherein the received response data comprises a “like” or “don't like” response for each of the polling audience users providing a response.

13. The method of claim 8, further comprising:
aggregating the number of polling audience users from which no response was received; and
presenting the number of non-responsive polling audience users to the requestor.

14. The method of claim 8, further comprising selecting a product for display via a graphical user interface based on the aggregated received response data.

15. A non-transitory computer readable medium storing computer executable instructions that, when executed, cause an apparatus at least to perform:
receiving request data from a requestor;
receiving polling audience selection data;
sending request data to a plurality of polling audience users associated with the polling audience selection data;
receiving response data associated with the request data from the polling audience users;
aggregating received response data; and
presenting the aggregated received response data.

16. The computer readable medium of claim 15, wherein the received request data includes a photograph taken in-store.

17. The computer readable medium of claim 16, wherein the aggregated received response data is presented to the requestor while the requestor is in-store.

18. The computer readable medium of claim 15, wherein the polling audience selection data includes at least one of the group of: age range limitation data, gender limitation data, geographic limitation data, education limitation data, music preference limitation data, or cuisine preference limitation data.

19. The computer readable medium of claim 15, wherein the received response data comprises a “like” or “don't like” response for each of the polling audience users providing a response.

20. The computer readable medium of claim 15, the computer readable medium further comprising instructions to:
aggregate the number of polling audience users from which no response was received; and
present the number of non-responsive polling audience users to the requestor.
